(19) United States
(12) Patent Application Publication
(10) Pub. No.: US 2026/0119514 A1
(43) Pub. Date: Apr. 30, 2026

(54) GENERATING CUSTOMIZED CONTENT USING A GENERATIVE MODEL

(71) Applicant: Pinterest, Inc., San Francisco, CA (US)

(72) Inventors: Alice Jenlin Chang, San Mateo, CA (US); David Ding-Jia Xue, San Francisco, CA (US); Jessica Chen, Milpitas, CA (US); Dong Hyun Lee, Walnut Creek, CA (US); Ricardo Casimilas, JR., Pembroke Pines, FL (US); Jiaqi Shen, Hoboken, NJ (US); Jay Priyadarshi, Irvine, CA (US)

(73) Assignee: Pinterest, Inc., San Francisco, CA (US)

(21) Appl. No.: 18/927,713

(22) Filed: Oct. 25, 2024

(51) Int. Cl. G06F 16/248; G06Q 50/00

(52) U.S. Cl. CPC G06F 16/248; G06Q 10/40

(57) ABSTRACT

Disclosed are systems and methods that generate a natural language prompt that is configured to be processed by a generative model, such as a large language model (LLM), and includes certain user information to facilitate the determination and/or generation of customized content for users of an online platform. For example, textual information associated with certain user information may be extracted and aggregated and incorporated into one or more natural language prompts, which may be processed by a generative model, such as an LLM, to generate a particular output based on the type of customized content being sought and/or generated for the user. The output may then be processed to determine and/or generate the customized content or the user.

### BACKGROUND

Many online platforms, such as social media platforms, social networking platforms, e-commerce platforms, and the like, offer online services such as search systems and content recommendation systems. Such systems typically aim to identify and serve content that is relevant to users accessing the systems and/or responsive to queries performed by the users. However, in identifying relevant and/or responsive content, many platforms often maintain a large corpus of content items (e.g., hundreds, billions, etc.) from which the content relevant and/or responsive content is identified. Accordingly, determining relevant and/or responsive content from such a large corpus of content can be difficult. To facilitate the determination of relevant and/or responsive content, many online platforms often train and/or maintain machine learning systems configured to determine and serve relevant and/or responsive content to users. However, configuring, tuning, training and/or maintaining machine learning systems are oftentimes expensive and/or resource intensive. This can be especially true when new types of content are sought to be identified and/or determined.

### BRIEF DESCRIPTION OF THE DRAWINGS

The foregoing aspects and many of the attendant advantages of the disclosed subject matter will become more readily appreciated as they are better understood by reference to the following description when taken in conjunction with the following drawings, wherein:

FIG. 1 is a block diagram illustrating an exemplary computing environment, according to exemplary embodiments of the present disclosure.

FIGS. 2A and 2B are block diagrams illustrating the determination and/or generation of content, according to exemplary embodiments of the present disclosure.

FIGS. 3A-3F illustrate exemplary user interfaces, according to exemplary embodiments of the present disclosure.

FIG. 4 is a flow diagram illustrating an exemplary content determination process, according to exemplary embodiments of the present disclosure.

FIGS. 5A-5C are flow diagrams illustrating exemplary content determination and presentation processes, according to exemplary embodiments of the present disclosure.

FIG. 6 is a block diagram illustrating an exemplary computing resource, according to exemplary embodiments of the present disclosure.

### DETAILED DESCRIPTION

As is set forth in greater detail below, embodiments of the present disclosure are generally directed to an exemplary systems and methods for generating a prompt that is configured to be processed by a generative model, such as a large language model (LLM), a multimodal generative model, and the like to facilitate the determination and/or generation of customized content for users of an online platform. In exemplary implementations, the prompt may be generated based on textual information associated with certain user information that may be extracted and aggregated to generate a user summary that describes one or more aspects of the user in connection with the online platform, one or more content items (e.g., images, video content, etc.), and/or text information associated with the one or more content items. The various information may then be incorporated into one or more natural language prompts, which may be processed by a generative model, such as an LLM, multimodal generative model, and the like, to generate a particular output based on the type of customized content being sought and/or generated for the user. The output may then be processed to determine and/or generate the customized content or the user.

In an exemplary embodiment, certain user information stored and maintained by an online service may be compiled to be included in generating a natural language prompt. According to aspects of the present disclosure, the user information may include information such as demographic information, user history information (e.g., content items with which the user interacted, types of interactions with content items, a frequency of interaction with content items, a recency of interaction with content items, etc.), items purchased by the user, user interests, user likes, user dislikes, and the like. From the compiled user information, text-based information associated with the user information may be extracted and aggregated for inclusion in the natural language prompt. The text-based information may include, for example, annotations, title information, category information, object information, descriptive information, file information, etc. associated with content items with which the user interacted, and the like. Accordingly, the aggregated text-based information may be included in one or more natural language prompts specifying that a particular output be generated by the generative model based on the aggregated text-based information and the particular customized content being determined and/or generated for the user.

In an exemplary implementation of the present disclosure, the one or more natural language prompts may be configured to facilitate determination of one or more aspects of the user that are determined from the user information, such as the user's aesthetics, tastes, preferences, interests, and/or vibes, one or more features or objects (e.g., travel destinations, animals, horoscopes, colors, celebrities, etc.) linked to the aspects of the user, and also identify relevant content items that are representative of the determined aesthetics, tastes, preferences, vibes, and/or the one or more features or objects (e.g., travel destinations, animals, horoscopes, colors, celebrities, etc.) linked to the aspects of the user. For example, the natural language prompt(s) including the aggregation of user information may be processed by a generative model, such as an LLM, and may instruct the generative model to provide an output that includes a summary or phrase that describes the aspect(s) of the user, such as the user's aesthetics, the linked features and/or objects, along with one or more targeted queries configured to request visual content items that may represent, illustrate, and/or embody the determined aspect of the user (e.g., the user's aesthetics, tastes, preferences, and/or vibes, etc.) and/or the linked features and/or objects, based on the aggregated user information provided in the natural language prompt(s).

In yet another exemplary implementation of the present disclosure, the one or more natural language prompts may be configured to facilitate generation of a personalized questionnaire, quiz, survey, poll, and the like. For example, the natural language prompt(s) including the aggregation of user information may be processed by a generative model, such as an LLM, and may instruct the generative model to generate a personalized questionnaire, quiz, survey, poll, etc. relating to a topic or category and/or topic that is relevant to the user. The natural language prompt(s) may further instruct the generative model to generate one or more conclusions, summaries, inferences, etc. relating to user based on the user's responses to questions of the questionnaire, quiz, survey, or poll and one or more queries for each conclusion, summary, inference, etc. and/or response to the questions included in the generated questionnaire, quiz, survey, or poll. The queries may be configured to request visual content items that are relevant to the questionnaire, quiz, survey, poll, etc. and/or the responses to the questions included in the questionnaire, quiz, survey, poll, etc. with which the questions are associated.

In yet another exemplary implementation of the present disclosure, one or more multimodal prompts may be generated that include a non-textual content item (e.g., an image, video content, an audio content, etc.) and textual information that, when processed by a multimodal generative model, is configured to generate a decision tree flowing from the non-textual content item and one or more queries for each node of the decision tree that are configured to retrieve content items that are relevant to the respective node of the decision tree. Further, a summary, phrase, caption, or the like may also be generated for each node of the decision tree. Accordingly, the non-textual content item (and any generated summary, phrase, or caption) may correspond to a root node of the decision tree, and each first level child node connected to the root node may correspond to a particular feature, aspect, characteristic, etc. of the non-textual content item associated with the root node, and the children node of each subsequent level of the decision tree may correspond to a further feature, aspect, characteristic, etc. of the respective parent node. For example, the multimodal prompt may include a content item with which the user has interacted (e.g., liked, shared, selected, viewed, etc.) and the textual information, which may include metadata or other textual information associated with the content item. Optionally, the textual information may also include a text based user summary, as described herein.

Accordingly, the multimodal prompt may instruct the multimodal model to process the prompt to determine and/or generate a decision tree including a root node corresponding to the content item included in the prompt, and each node flowing from the root node includes a summary, phrase, caption, question, etc. that further defines and/or specifies a feature or aspect of its respective parent node. Further, the multimodal prompt may instruct may further instruct the multimodal model to generate targeted queries associated with each node of the decision tree that are configured to retrieve content that is representative of the corresponding node of the decision tree. The summaries, phrases, captions, questions associated with each node of the decision tree may then be presented to and selected by the user, as the user traverses the decision tree. Additionally, at each node of the decision tree, the targeted queries associated with the node may be performed so as to identify and present content items that are relevant to each respective node.

Advantageously, the exemplary embodiments of the present disclosure can facilitate generating relevant and customized content without expending the resources for configuring, tuning, maintaining, etc. a new machine learning model in connection with the determination and/or generation of a particular type of content that is being sought. Further, the determination and generation of relevant and customized content according to exemplary embodiments of the present disclosure can facilitate increased user engagement with the online platform, encourage further exploration into content that the user had not previously consumed, and the like.

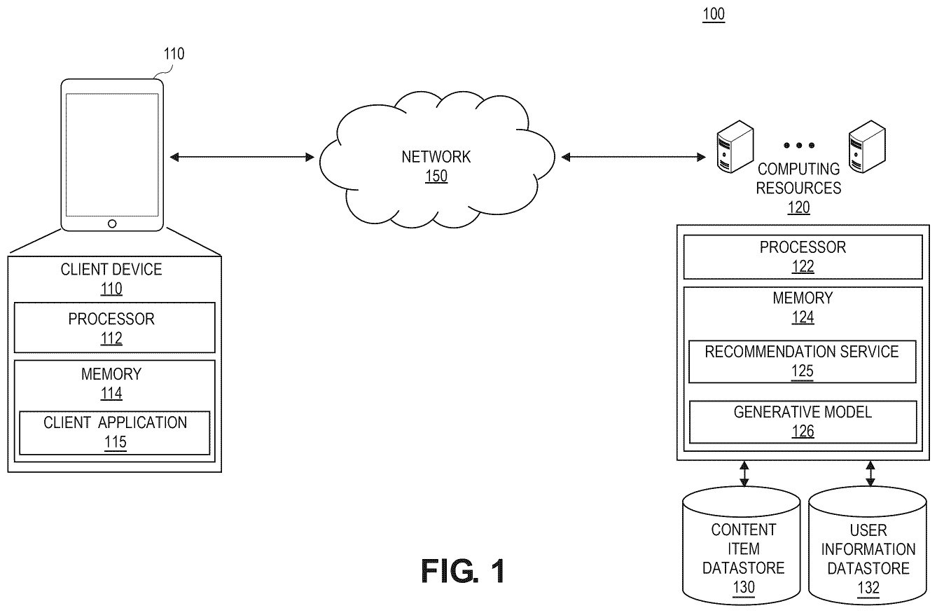

FIG. 1 is an illustration of an exemplary computing environment, according to exemplary embodiments of the present disclosure.

As shown in FIG. 1, computing environment 100 may include one or more client devices 110, also referred to as user devices, for connecting over network 150 to access computing resources 120. Client device 110 may include any type of computing device, such as a smartphone, tablet, laptop computer, desktop computer, wearable, etc., and network 150 may include any wired or wireless network (e.g., the Internet, cellular, satellite, Bluetooth, Wi-Fi, etc.) that can facilitate communications between client device 110 and computing resources 120. Computing resources 120 may include one or more processor(s) 122 and one or more memory 124, which may store one or more applications, such as recommendation service 125 and generative model 126, that may be executed by processor(s) 122 to cause processor(s) 122 of computing resources 120 to perform various functions and/or actions. It is noted that computing environment 100 is a logical configuration and is not necessarily an actual configuration. Accordingly, there may be numerous ways in which computing environment 100 may be implemented, and FIG. 1 should be viewed as illustrative and not limiting.

According to aspects of the present disclosure, computing resources 120 may represent at least a portion of a networked computing system that may be configured to provide online applications, services, computing platforms, servers, and the like, such as a social networking service, social media platform, e-commerce platform, content recommendation services, search services, and the like, that may be configured to execute on a networked computing system. Further, computing resources 120 may communicate with one or more datastore(s), such as content item datastore 130, which may be configured to store and maintain a corpus of digital content items, user information datastore 132, which may be configured to store and maintain user profile information, user actions, user interactions, user preferences, and/or user histories associated with users of an online service provided by computing resources 120 that may be processed in connection with the generation and/or determination of relevant and customized content to be served to client device 110. The content items stored and maintained by content item datastore 130 may include any type of digital content, such as digital images, videos, documents, advertisements, and the like.

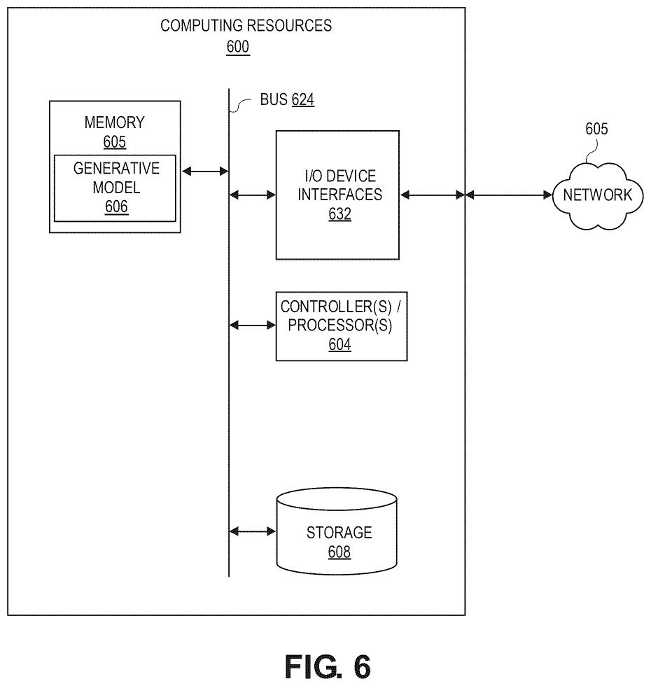

According to exemplary implementations of the present disclosure, computing resources 120 may be representative of computing resources that may form a portion of a larger networked computing platform (e.g., a cloud computing platform, and the like), which may be accessed by client device 110. Computing resources 120 may provide various services and/or resources and do not require end-user knowledge of the physical premises and configuration of the system that delivers the services. For example, computing resources 120 may include “on-demand computing platforms,” “software as a service (Saas),” “infrastructure as a service (IaaS),” “platform as a service (PaaS),” “platform computing,” “network-accessible platforms,” “data centers,” “virtual computing platforms,” and so forth. As shown in FIG. 1, computing resources 120 may be configured to execute and/or provide a social media platform, a social networking service, a recommendation service, a search service, an e-commerce platform, or any other form of interactive computing. Example components of a remote computing resource, which may be used to implement computing resources 120, are discussed below with respect to FIG. 6.

As illustrated in FIG. 1 client device 110 may access and/or interact with recommendation service 125 through network 150 via one or more applications 115 stored in memory 114 and operating and/or executing on client device 110. For example, users associated with client device 110 may launch and/or execute such an application on client device 110 to access and/or interact with applications and/or services executing on computing resources 120 via network 150. According to aspects of the present disclosure, a user may, via execution of applications 115 on client device 110, access or log into services executing on computing resources 120 by submitting one or more credentials (e.g., username/password, biometrics, secure token, etc.) through a user interface presented on client device 110.

Once logged into services executing on remote computing resources 120, users associated with client device 110 may navigate, view, access, and/or otherwise consume content items on client device 110 as part of a social media platform or environment, a networking platform or environment, an e-commerce platform or environment, or through any other form of interactive computing. In connection with the user's activity on client device 110 with the online services provided by computing resources 120, a request for the determination and/or generation of customized content may be received from client device 110 by computing resources 120. According to aspects of the present disclosure, the request for the determination and/or generation of customized content may be an explicit request. Alternatively and/or in addition, the request may be implicit. For example, the request for the determination and/or generation of customized content may be included in a query (e.g., a text-based query, an image query, etc.), a request to access a homepage and/or home feed, a request for recommended content items, browsing and/or consuming content via the service, an interaction with a content item, and the like. Alternatively and/or in addition, services executing on remote computing resources 120 may push customized content, which may have been determined and/or generated according to exemplary embodiments of the present disclosure, to client device 110. For example, services executing on remote computing resources 120 may push the customized content to client device 110 when a user associated with client device 110 accesses the user's homepage or home feed, interacts with a content item, on a periodic basis, after a certain period of time has elapsed, based on certain activity associated with client device 110, upon identification of relevant and/or recommended content items that may be provided to client device 110, and the like.

In response to a request for the determination and/or generation of customized content, recommendation service 125 may obtain various information and parameters associated with the user to be used in connection with the determination and/or generation of the customized content. For example, the various information and parameters, such as user history information (e.g., content items with which the user interacted, types of interactions with content items, a frequency of interaction with content items, a recency of interaction with content items, etc.), items purchased by the user, user interests, user likes, user dislikes, and the like, may be obtained from user information datastore 132. The obtained information and parameters may be processed by recommendation service 125 to generate one or more natural language prompts configured to be processed by a generative model (e.g., generative model 126) to determine and/or generate customized content. According to aspects of the present disclosure, textual information associated with the user information may be extracted and aggregated for inclusion in the one or more natural language prompts. For example, the text-based information may include annotations, title information, category information, object information, descriptive information, file information, etc. associated with user actions the user may have taken and/or content items with which the user interacted. In certain implementations, the textual information may be limited to a particular timeframe (e.g., over the past one month, over the past three months, over the past six months, over the past year, etc.).

Optionally, in extracting and aggregating the user information for inclusion in the natural language prompt(s), the user information may be weighted based on the parameters associated with the user information. For example, the user actions included in the user information may be weighted based on certain parameters, such as a recency of the action (e.g., more recent actions are provided a higher weight), a frequency of the action (e.g., more frequent actions are provided a higher weight), a type of action (e.g., certain actions such as sharing a content item may be provided a higher weight than other actions, such as liking a content item, etc.), and the like. Accordingly, in aggregating the textual information associated with the user information, the textual information associated with user actions having higher weights may be prescribed greater importance relative to textual information associated with user actions that are associated with a lower weight.

The aggregated textual information may be incorporated into one or more natural language prompts that may be processed by a generative model (e.g., generative model 126) to determine and/or generate certain customized content for client device 110. For example, the aggregated user information may include a sequence of n-grams, tokens, etc. and be incorporated into a prompt that specifies a particular output to be generated by the generative model. In one exemplary implementation, the natural language prompt may include the aggregated textual information extracted from the user information and may specify that the generative model generate an output that includes a summary or phrase that describes an aspect of the user, such as a user's aesthetic, taste, vibe, preference, etc., one or more features or objects (e.g., travel destinations, animals, horoscopes, etc.) linked to the aspects of the user, and the like, based on the textual information extracted from the user information. Optionally, the natural language prompt may also specify that the generative model also generate one or more queries configured to retrieve visual content items that may be representative of and/or embody the aspect of the user, such as the user's aesthetic, taste, vibe, preference, etc., and the one or more features or objects (e.g., travel destinations, animals, horoscopes, colors, celebrities, etc.) linked to the aspects of the user based on the textual information extracted from the user information. According to certain aspects of the present disclosure, the summary or phrase that describes an aspect of the user, such as the user's aesthetic, taste, vibe, preference, etc., may be presented on client device 110 in accordance with a template format/layout, and the natural language prompt may specify that the summary or phrase that describes the aspect of the user, such as user's aesthetic, taste, vibe, preference, etc. and the one or more queries be generated so that content may be presented on client device 110 in accordance with the template format/layout. For example, the summary or phrase that describes the aspect of the user, such as the user's aesthetic, taste, vibe, preference, etc., may be presented along with a collage of visual content items that represent, illustrate, or are otherwise expressive of aspects of the user's aesthetic, taste, vibe, preference, etc. Accordingly, the template format may define a layout (e.g., positioning, arrangement, etc.) of the content items to be included in the collage and the type of visual content items to be presented at each position in the collage. For example, each content item included in the collage may illustrate and/or represent a particular aspect of the user's aesthetic, taste, vibe, preference, and the like. Thus, the queries generated by the generative model may relate to the corresponding aspects of the user's aesthetic, taste, vibe, preference, etc. to be represented by content items at each position in the collage.

Alternatively and/or in addition, the natural language prompt may include the aggregated textual information extracted from the user information and may specify that the generative model generate an output that specifies generating a questionnaire, quiz, survey, poll, etc. based on the textual information extracted from the user information. The generated questionnaire, quiz, survey, poll, etc. may relate to a topic, interest, subject, etc. of the user that may be determined from the aggregated textual information and may include one or more questions, and each question may include two or more selectable responses. Further, the prompt may further instruct the generative model to generate one or more conclusions, summaries, inferences, etc. relating to the questionnaire, quiz, survey, poll, etc. for each combination of user's responses to the questions included in the questionnaire, quiz, survey, poll, etc. According to certain aspects of the present disclosure, the natural language prompt may also specify that the generative model generate one or more targeted queries for each conclusion, summary, inference, etc. and/or response associated with the questions of the questionnaire, quiz, survey, poll, etc. that are configured to request visual content items that may relate to the corresponding response in the questionnaire, quiz, survey, poll, etc.

According to certain exemplary embodiments of the present disclosure, recommendation service 125 may be configured to generate one or more multimodal prompts configured to be processed by a multimodal model (e.g., generative model 126) to determine and/or generate customized content. For example, recommendation service 125 may receive, via an interaction with client device 110, an indication of an interaction with a content item. Accordingly, the content item and textual information associated with the content item (e.g., metadata such as title, filename, annotations, description, category, etc.) may be included in a multimodal prompt that may be processed by generative model 126 to generate a customized output. Optionally, additional textual information, such as a text based user summary, and the like, may also be included in the multimodal prompt(s). The multimodal prompt may specify that generative model 126 generate an output that includes a decision tree having a root node that corresponds to the content item and subsequent nodes (e.g., decision nodes, leaf nodes, etc.) that correspond to an aspect derived from the node's respective parent node. Further, the prompt may further instruct the generative model to generate an output that includes one or more queries for each node of the decision tree that are configured to retrieve content that is relevant to the particular node.

After generation of the prompt, the prompt may be processed by a generative model (e.g., generative model 126) to generate an output. The output generated by the generative model may then be processed to determine the content to be served on client device 110. In the exemplary implementation where the natural language prompt instructs the generative model may process the prompt to generate an output that includes a summary or phrase that describes the aspect of the user, such as a user's aesthetic, taste, vibe, preference, etc. and one or more queries configured to retrieve visual content items that may be representative of and/or embody the aspect of the user, the generative model may generate an output that includes a summary, phrase, or caption that represents the user's aesthetic, taste, vibe, preference, etc. and one or more queries configured to retrieve visual content items that may be representative of and/or embody the aspect(s) of the user. Accordingly, the summary, phrase, or caption that represents the user's aesthetic, taste, vibe, preference, etc. and the queries may be performed to determine content items that may be representative of and/or embody the aspect(s) of the user. After content items responsive to the queries have been determined, the summary, phrase, or caption that describes the aspect of the user, such as the user's aesthetic, taste, vibe, preference, etc., determined by the generative model may be presented to the user on client device 110, along with a collage of the content items returned in response to the queries.

In another exemplary implementation where the generated natural language prompt instructs a generative model to generate a questionnaire, quiz, survey, poll, etc. and queries for each response to the questions included in the questionnaire, quiz, survey, poll, etc., the generative model may process the prompt to generate an output that includes a questionnaire, quiz, survey, poll, etc., one or more conclusions, summaries, inferences, etc., and queries associated with the conclusions, summaries, inferences, etc. and/or responses to the questions included in the questionnaire, quiz, survey, poll, etc. Accordingly, the questionnaire, quiz, survey, poll, etc. may be presented on client device 110 (e.g., via a user interface, etc.) and a response to each question of the questionnaire, quiz, survey, poll, etc. may be received via an interaction with client device 110 (e.g., via the user interface). The user's responses to the questionnaire, quiz, survey, poll, etc. may be logged, along with the queries associated with each of the user's responses to the questionnaire, quiz, survey, poll, etc., and at the conclusion of the questionnaire, quiz, survey, poll, etc., the queries may be performed to identify and/or retrieve content items that are responsive to the queries. After content items responsive to the queries have been determined, a conclusion, summary, inference, etc. relating to the questionnaire, quiz, survey, poll, etc. and based on the user responses may be presented to the user on client device 110, along with one or more of the content items returned in response to the queries.

In another exemplary implementation where the prompt includes a content item and instructs the generative model to generate an output that includes a decision tree and queries associated with each node of the decision tree, the generative model may process the prompt to generate an output that includes a summary, phrase, caption, or question that corresponds to each node of the decision tree, as well as queries associated with each node of the decision tree. In an exemplary implementation, the root node of the decision tree may correspond to the content item included in the prompt, the connected child nodes may correspond to certain aspects, features, or characteristics of the content item, and so forth. Accordingly, the output may be processed so that the content item corresponding to the root node may first be presented on client device 110, along with summaries, phrases, or captions corresponding to the children nodes connected to the root node and one or more content items retrieved in response to the queries associated with the root node. The summaries, phrases, or captions corresponding to the connected child nodes may be in the form of questions and/or further text captions corresponding to particular aspects of the root node. One of the summaries, phrases, or captions corresponding to a particular child node may be selected by a user via an interaction with client device 110. Subsequently, summaries, phrases, or captions corresponding to the children nodes connected to the selected node, along with one or more content items retrieved in response to the queries associated with the selected node. Accordingly, the user may continue to traverse through the generated decision tree via selection of summaries, phrases, or captions corresponding to further child nodes. Additionally, at each node of the decision tree, the targeted queries associated with the node may be performed so as to identify and present content items that are relevant to each respective node.

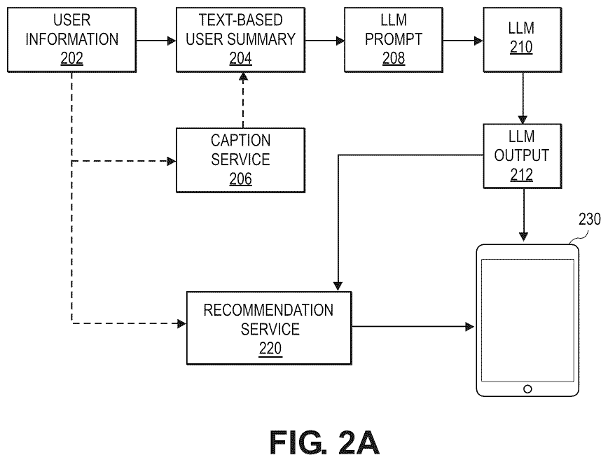

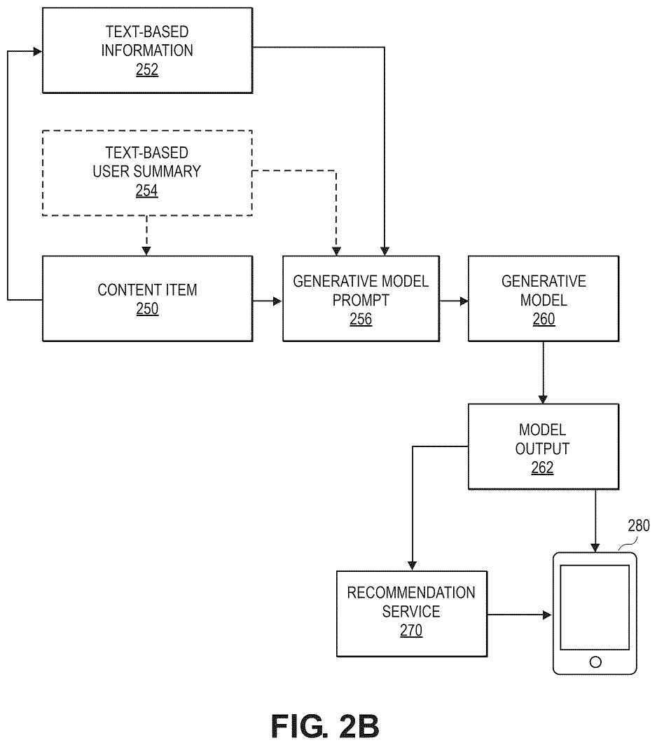

FIG. 2A is a block diagram illustrating the determination and/or generation of content, according to exemplary embodiments of the present disclosure.

As shown in FIG. 2A, user information 202 may be utilized to generate one or more LLM prompts 208 in connection with the determination and/or generation of content, which may be presented to a user on client device 230. As illustrated, user information 202 may be processed to extract and aggregate textual information to generate text-based user summary 204. Text-based user summary may then be used to generate a natural language prompt, such as LLM prompt 208, which may be processed by a generative model, such as LLM 210 to generate LLM output 212. LLM output 212 may include generated content that may be presented on client device 230 and queries or other searches that may be performed by a search service (e.g., recommendation service 220) to identify responsive content that may also be presented on client device 230.

In the exemplary implementation illustrated in FIG. 2A, textual information associated with user information 202 may be extracted and aggregated to generate text-based summary 204. According to aspects of the present disclosure, user information may include information relating to the user that is stored and/or maintained by an online platform (e.g., a social networking service, social media platform, e-commerce platform, content recommendation services, search services, etc.), and may include information such as demographic information, user history information (e.g., content items with which the user interacted, types of interactions with content items, a frequency of interaction with content items, a recency of interaction with content items, etc.), items purchased by the user, user interests, user likes, user dislikes, and the like. For example, the textual information may include textual information associated with the user information, such as annotations, title information, category information, object information, descriptive information, file information, generated captions, etc. associated with user actions the user may have taken and/or content items with which the user interacted, user demographic information, and the like.

According to certain aspects of the present disclosure, in exemplary implementations where user information 202 may include visual content items that do not include textual information, a caption may be generated for any such visual content items. For example, visual content items not including textual information may be processed by caption service 206 to generate a caption for any such visual content items. According to exemplary implementations, caption service may employ an image encoder and a language model, such as BLIP-2, FLAMINGO80B, VQAv2, GPT, etc. to process the content items and generate a caption for each content item. For example, a caption, as used herein, may include a short descriptive or explanatory text, that describes or explains the visual content item and/or the representations/illustrations included in the visual content item. Accordingly, any captions generated by caption service 206 may be included in text-based user summary 204 as textual information for any content items that do not include any associated textual information.

Additionally, in extracting and aggregating textual information from user information 202 to generate text-based user summary 204, user information 202 may be weighted based on the parameters associated with user information 202. For example, the items (e.g., user actions, content items, etc.) included in user information 202 may be weighted based on certain parameters, such as a recency of the action (e.g., more recent actions are provided a higher weight), a frequency of the action (e.g., more frequent actions are provided a higher weight), a type of action (e.g., certain actions such as sharing a content item may be provided a higher weight than other actions, such as liking a content item, etc.), and the like. Accordingly, in aggregating the textual information associated with user information 202 to generate text-based user summary 204, the textual information associated with user actions having higher weights may be prescribed greater importance relative to textual information associated with user actions that are associated with a lower weight. Accordingly, text-based user summary 204 may include a concatenation of the textual information extracted from user information 202. For example, text-based user summary 204 may aggregate textual information extracted from user information 202 into a sequence of tokens, n-grams, and the like. Further, the sequence used in concatenating the textual information may correspond to the weightings associated with the items included in user information 202 (e.g., the textual information may be arranged in an order of decreasing weights, increasing weights, and the like). Further, the natural language prompt (e.g., LLM prompt 208) that includes text-based user summary 204 may expressly specify if and how the aggregated textual information is arranged according to their corresponding weightings.

As illustrated in FIG. 2A, text-based user summary 204 may be used to generate a natural language prompt configured to be processed by a generative model, such as LLM prompt 208, to be processed by a generative model (e.g., LLM 210) to generate a particular output for the determination and/or generation of customized content to be served to a user. For example, text-based user summary 204 may be incorporated into LLM prompt 208 that instructs a generative model, such as LLM 210, how to process text-based user summary 204 in generating a particular output. Accordingly, LLM prompt 208 may specify the type of output to be generated, how text-based user summary 204 is to be processed (e.g., weightings, an order of importance, etc.), and the like.

In an exemplary implementation, LLM prompt 208 may include text-based user summary 204 extracted from user information 202 and may specify that the generative model generate an output that includes a summary or phrase that describes the aspect of the user, such as a user's aesthetic, taste, vibe, preference, etc., based on text-based user summary 204, which was extracted from user information 202. Further, LLM prompt 208 may specify that the text, tokens, and/or text terms included in text-based user summary 204 are arranged in a certain order of importance (e.g., decreasing, increasing, etc.) based on weightings associated with corresponding features within user information 202. Optionally, LLM prompt 208 may also instruct the generative model to generate one or more queries configured to retrieve visual content items that may be representative of and/or embody determined the aspect of the user, such as the user's aesthetic, taste, vibe, preference, etc., one or more features or objects (e.g., travel destinations, animals, horoscopes, colors, celebrities, etc.) linked to the aspects of the user, and the like, based on text-based user summary 204, which was extracted from the user information 202.

According to certain aspects of the present disclosure, the summary or phrase that describes the aspect of the user, such as the user's aesthetic, taste, vibe, preference, etc., and/or the linked features or objects may be presented to a user (e.g., on a client device) in accordance with a template format/layout, and LLM prompt 208 may specify that the summary or phrase and the one or more queries be generated in contemplation that the content may be presented to the user in accordance with the template format/layout. For example, the summary or phrase may be presented along with a collage of visual content items that represent, illustrate, or are otherwise expressive of the aspect of the user. Accordingly, the template format may define a layout (e.g., positioning, arrangement, etc.) of the content items to be included in the collage and the type of visual content items to be presented at each position in the collage. For example, each content item included in the collage may illustrate and/or represent a particular aspect of a user's aesthetic, taste, vibe, preference, and the like. Thus, the queries generated by the generative model may relate to the corresponding aspects of the user's aesthetic, taste, vibe, preference, etc. to be represented by content items at each position in the collage. For example, in an exemplary implementation where a representative natural language seeking such an output may include:
Generate a two word phrase that describes and is indicative of a user's mood, aesthetic, vibe, preferences, and/or tastes based on the user summary <U>, which includes an aggregation of text-based information associated with the user's history and is arranged in a sequence of decreasing importance. Also generate five queries for four different aspects related to the two word phrase that will identify content items that may illustrate or represent the different aspects of the two word phrase.
   where <U> may include a text-based user summary that was generated based on an aggregation of textual information associated with certain user information.

Alternatively and/or in addition, in an exemplary implementation where the representative natural language is configured to also obtain features and/or linked to aspects of the user, such a prompt may include:
Generate a caption or phrase that describes and is indicative of a user's mood, aesthetic, vibe, preferences, and/or tastes based on the user summary <U>, which includes an aggregation of text-based information associated with the user's history over the past six months and is not weighted to emphasize any aspect of the user's history. Also generate a synopsis of the user that is to include a timeline including highlights of the user's activities, any recurring or dominant patterns, tastes, and interests of the user. Also, generate, based on the user's mood, aesthetic, vibe, preferences, tastes, and/or synopsis, a location, a spirit animal, a color, a food, an author, and a celebrity that may represent the user or is correlated with the determined aspects of the user. Also generate five queries for the synopsis, each location, spirit animal, color, food, author, and celebrity that will identify content items that may illustrate or represent the synopsis, each location, spirit animal, color, food, author, and celebrity.
   where <U> may include a text-based user summary that was generated based on an aggregation of textual information associated with certain user information.

Alternatively and/or in addition, LLM prompt 208 may include text-based user summary 204 extracted from user information 202 and may instruct the generative model to generate a questionnaire, quiz, survey, poll, etc. based on text-based user summary 204 extracted from user information 202. The generated questionnaire, quiz, survey, poll, etc. may relate to a topic, interest, subject, etc. of the user that may be determined from text-based user summary 204 and may include one or more questions, and each question may include two or more selectable responses. Further, LLM prompt 208 may further instruct the generative model to generate one or more conclusions, summaries, inferences, etc. (e.g., for each combination of user responses) relating to the questionnaire, quiz, survey, poll, etc. based on the user's responses to the questions included in the questionnaire, quiz, survey, poll, etc. According to certain aspects of the present disclosure, LLM prompt 208 may also specify that the generative model generate one or more targeted queries for each conclusion, summary, inference, etc. and/or response associated with the questions of the questionnaire, quiz, survey, poll, etc. that are configured to request visual content items that may relate to the corresponding response in the questionnaire, quiz, survey, poll, etc. For example, a representative natural language seeking such an output may include:
Generate a four question multiple choice questionnaire relating to an interest of a user based on the user summary U, which includes an aggregation of text-based information associated with the user's history and is arranged in a sequence of decreasing importance. Also generate one or more conclusions that can be drawn about the user based on the responses provided by the user and queries for each possible response to the questions or each conclusion that will identify content items that may illustrate or represent the conclusions or the responses to the questions.
   where U may include a text-based user summary that was generated based on an aggregation of textual information associated with certain user information.

After generation of LLM prompt 208, LLM prompt 208 may be processed by a generative model, such as LLM 210, to generate an output, such as LLM output 212. LLM output 212 generated by LLM 210 may then be processed to determine the content to be served on client device 230. In the exemplary implementation where LLM prompt 208 instructs LLM 210 to generate an output that includes a summary or phrase that describes the aspect of the user, such as the user's aesthetic, taste, vibe, preference, etc., and one or more queries configured to retrieve visual content items that may be representative of and/or embody the aspect of the user, LLM output 212 may include the generated summary or phrase (e.g., related to the user's aesthetic, taste, vibe, preference, etc.) and the one or more queries that are configured to retrieve visual content items that may be representative of and/or embody the user's aesthetic, taste, vibe, preference, etc. Accordingly, the queries included in LLM output 212 may be performed by recommendation service 220 to identify and/or retrieve content items that are responsive to the queries. Optionally, user information 202 may also be processed by recommendation service 220 in performing the queries to identify content that is more relevant to the user. After content items responsive to the queries have been determined, the summary or phrase specified in LLM output 212, along with content items returned in response to the queries performed by recommendation service 220 may be presented on client device 230.

In another exemplary implementation where LLM prompt 208 instructs LLM 210 to generate an output including a questionnaire, quiz, survey, poll, etc. relating to a topic, interest, category, etc. determined from text-based user summary 204 included in LLM prompt 208, conclusions, summaries, inferences, etc. relating to the user based on the user's responses to questions included in the questionnaire, quiz, survey, poll, etc., and queries for each response to the questions included in the questionnaire, quiz, survey, poll, etc., LLM output 212 may include a questionnaire, quiz, survey, poll, etc. having one or more questions with corresponding possible response, one or more conclusions, summaries, inferences, etc. corresponding to each combination of possible user responses, and queries associated with the conclusions, summaries, inferences, etc. and/or the various responses to the questions included in the questionnaire, quiz, survey, poll, etc. Accordingly, as shown in FIG. 2A, the questionnaire, quiz, survey, poll, etc. included in LLM output 212 may be presented on client device 230 (e.g., via a user interface, etc.) and a response to each question of the questionnaire, quiz, survey, poll, etc. may be received via an interaction with client device 230 (e.g., via the user interface). The user's responses to the questionnaire, quiz, survey, poll, etc. may be logged, along with the queries associated with each of the user's responses to the questionnaire, quiz, survey, poll, etc., and at the conclusion of the questionnaire, quiz, survey, poll, etc., the queries may be performed by recommendation service 220 to identify and/or retrieve content items that are responsive to the queries. Optionally, user information 202 may also be processed by recommendation service 220 in performing the queries to identify content that is more relevant to the user. After content items responsive to the queries have been determined, a conclusion, summary, inference, etc. relating to the questionnaire, quiz, survey, poll, etc. and based on the user responses may be presented to the user on client device 230, along with one or more of the content items returned in response to the queries performed by recommendation service 220.

FIG. 2B is a block diagram illustrating the determination and/or generation of content, according to exemplary embodiments of the present disclosure.

As shown in FIG. 2B, generative model prompt 256 may be generated based on content item 250 and text-based information 252. Content item 250 may include any non-textual content item, such as an image, video, and the like, and text-based information 252 may include textual information extracted from content item 250. For example, text-based information 252 may include metadata associated with content item 250, such as a title associated with content item 250, a filename for content item 250, annotations associated with content item 250, descriptions of content item 250, categories or labels associated with content item 250, and the like. Optionally, generative model prompt 256 may also be based on text-based user summary 254. Generative model prompt 256 may then be processed by a generative model, such as generative model 260, which may include a multimodal generative model configured to include a multimodal prompt that may include textual information, a content item (e.g., an image, a video file, an audio file, etc.), and the like, to generate model output 262. Model output 262 may include generated content that may be processed and presented on client device 230. Further, model output 262 may also include queries or other searches that may be performed by a search service (e.g., recommendation service 270) to identify responsive content that may also be presented on client device 280.

As described herein, text-based user summary 254 may include information extracted and aggregated from user information maintained by an online service. For example, text-based user summary 254 may include information such as demographic information, user history information (e.g., content items with which the user interacted, types of interactions with content items, a frequency of interaction with content items, a recency of interaction with content items, etc.), items purchased by the user, user interests, user likes, user dislikes, and the like. The textual information associated with content items may include textual information associated with the user information, such as annotations, title information, category information, object information, descriptive information, file information, generated captions, etc. associated with user actions the user may have taken and/or content items with which the user interacted, user demographic information, and the like. Further, text-based user summary 254 may be weighted (e.g., recency weighted, etc.) based on certain parameters associated with the information included in text-based user summary 254, such as a recency of the information (e.g., more recent actions are provided a higher weight), a frequency of the action (e.g., more frequent actions a provided a higher weight), a type of the action (e.g., certain actions such as sharing a content item may be provided a higher weight than other actions, such as liking a content item, etc.), and the like. Accordingly, the textual information having higher weights may be prescribed greater importance relative to textual information that are associated with a lower weight. Accordingly, text-based user summary 254 may include a concatenation of weighted textual information associated with a user, where the sequence used in concatenating the textual information may correspond to the weightings associated with the items included in text-based user summary 254 (e.g., the textual information may be arranged in an order of decreasing weights, increasing weights, and the like).

As illustrated in FIG. 2B, generative model prompt 256 may be generated to be processed by a generative model, such as generative model 260 (e.g., a multimodal generative model, etc.) to generate a particular output for the determination and/or generation of customized content to be served to a user. For example, model prompt 256 may specify the type of output to be generated, how content item 250 and text-based information 252 are to be processed (e.g., weightings, an order of importance, etc.), and the like.

In an exemplary implementation, generative model prompt 256 may instruct the generative model to generate an output (e.g., model output 262) that includes a decision tree and one or more queries associated with each node of the decision tree. A root node of the generated decision tree may be associated with content item 250, and each child node of the decision tree may be associated with a particular feature, aspect, characteristic, etc. of the parent node to which it is directly connected. In an exemplary implementation where the content item included in generative model prompt 256 includes an image of a skier posing for a picture at the top of a mountain next to a helicopter, a decision tree may be generated with a root node associated with the image itself and four child nodes where a first child node is associated with heli-skiing, a second child node is associated with skiing clothing, and a third child node is associated with ski equipment. Further, a textual representation may also be generated for each child node (e.g., “do you want to explore heli-skiing?”, “are you interested in skiing clothing?”, “let's see more ski equipment”, etc.), as well as one or more queries for each node of the decision tree that are configured to return content items that are relevant to each respective node. Subsequent levels of the decision tree may correspond to more specific features associated with the parent nodes to which they are connected. Accordingly, the in illustrated example, the child nodes connected to the node regarding skiing clothing may relate to aspects such as the layering of skiing clothing, ski jackets, ski pants, ski accessories, and the like.

For example, in an exemplary implementation where a representative natural language seeking such an output may include:
Generate a decision tree having four levels, based on content item <X> and text summary <T> for content item <X>. The decision tree is to include: a root node of the that includes the content item <X>; at least three, but not more than five, first level child nodes that are directed connected to the root node and each relate to a different feature of the content item; and each subsequent level of child nodes should include at least three, but not more than five, child nodes and each such child node should relate to a further specific feature of the parent node to which it is directly connected. The features of each child node of the decision tree is to be summarized in a caption or question that may be presented to a user to allow a user to traverse the decision tree. Also generate five queries for each node of the decision tree that may illustrate or represent the node of the decision tree.
   where <X> may include the non-textual content item and <T> may include the textual information associated with the content item.

After generation of generative model prompt 256, generative model prompt 256 may be processed by a generative model, such as generative model 260, to generate an output, such as model output 262. Model output 262 generated by generative model 260 may then be processed to determine the content to be served on client device 280. In the exemplary implementation where generative model prompt 256 instructs generative model 260 to generate an output that includes a decision tree, model output 262 may include the generated the decision tree and the one or more queries that are configured to retrieve visual content items that may be representative of and/or embody each node of the decision tree. Accordingly, the decision tree included in model output 262 may be processed and presented via a user interface on client device 280 to allow a user to traverse the decision tree, and the queries included in model output 262 may be performed by recommendation service 270 to identify and/or retrieve content items that are responsive to the queries.

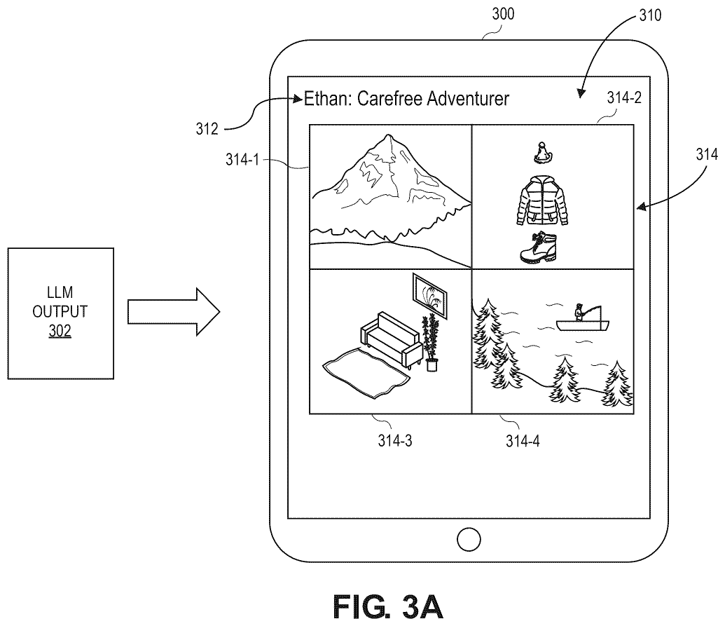

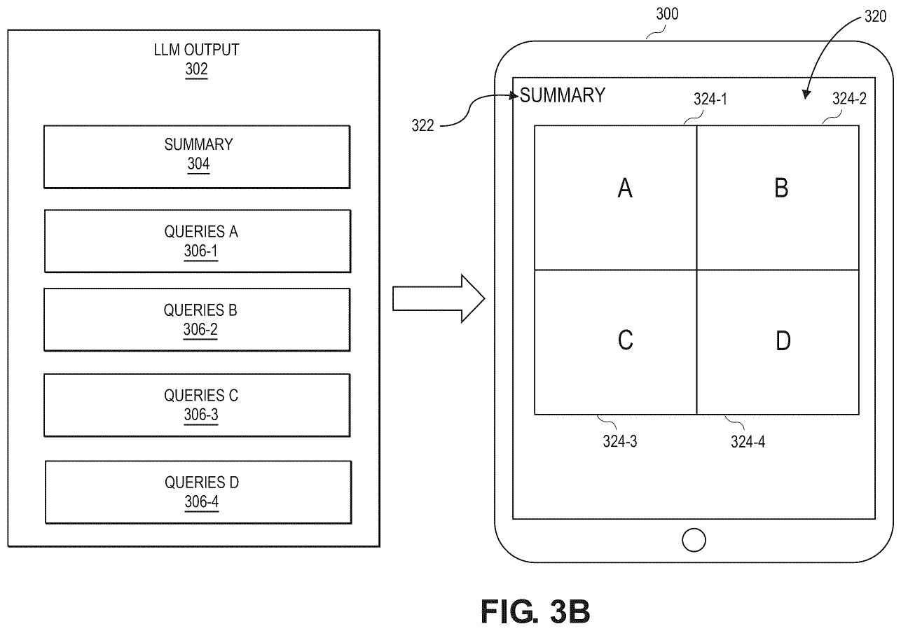

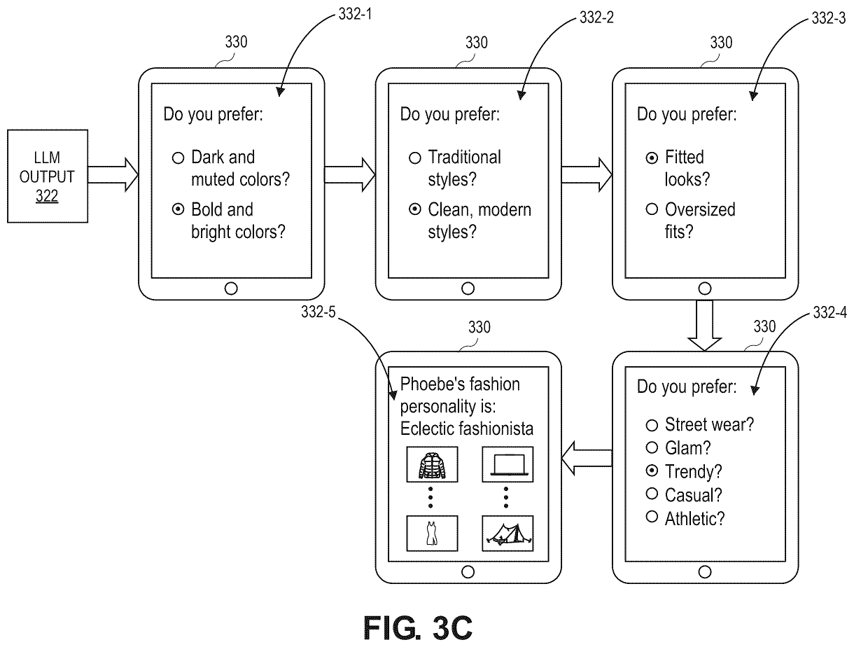

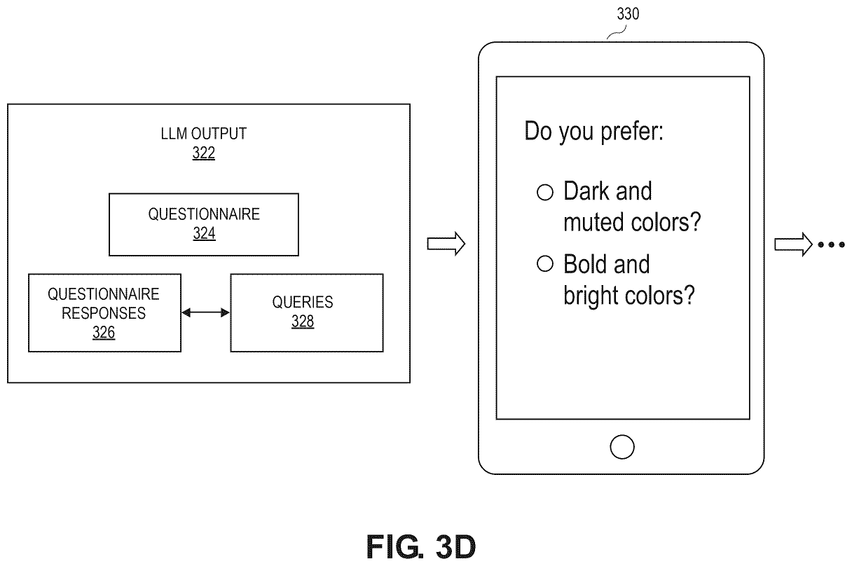

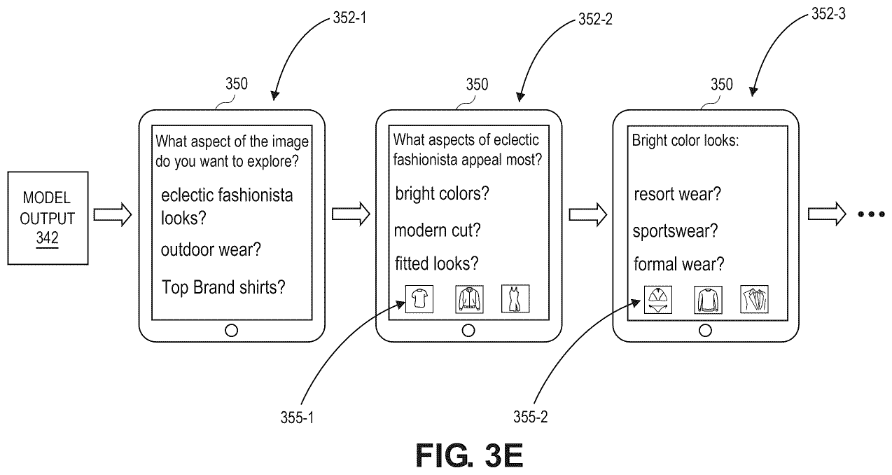

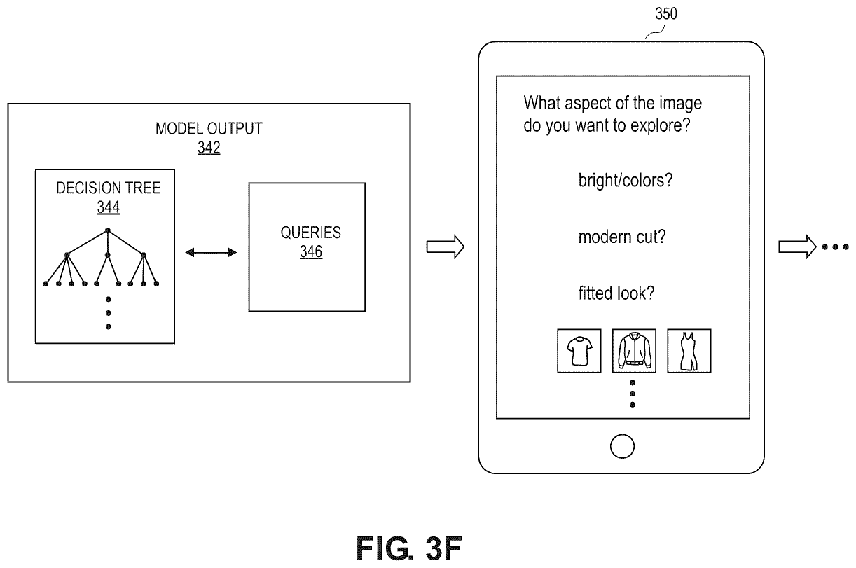

FIGS. 3A-3F illustrate exemplary user interfaces, according to exemplary embodiments of the present disclosure. FIG. 3A illustrates an implementation where one or more natural language prompts may be configured to facilitate determination of a user's aesthetics, tastes, preferences, and/or vibes and also identify relevant content items that are representative of the determined aesthetics, tastes, preferences, and/or vibes, FIG. 3B illustrates an implementation where the content is presented in accordance with a predetermined layout, FIGS. 3C and 3D illustrate an implementation where one or more natural language prompts may be configured to facilitate generation of a personalized questionnaire, quiz, survey, poll, etc., and FIGS. 3E and 3F illustrate an implementation where one or more prompts may be configured to facilitate determination of a decision based on a content item and also identify relevant content items that are relevant to nodes of the decision tree to facilitate exploration of certain aspects of the content item.

As shown in FIG. 3A, LLM output 302 may be processed to serve content on client device 300 via user interface 310. As illustrated, user interface 310 may include an indication 312 of a summary or phrase associated with an aspect of the user, such as the user's aesthetic, taste, vibe, preference, etc., which may have been determined by a generative model and specified in LLM output 302, and visual content items 314, which may have been retrieved in response to queries, which may have been determined by a generative model and specified in LLM output 302. Accordingly, LLM output 302 may have been generated by a generative model in response to processing one or more natural language prompts configured to instruct the generative model to generate a user's aesthetics, tastes, preferences, and/or vibes and targeted queries designed to retrieve visual content items that represent, illustrate, or are otherwise expressive of aspects of the user's aesthetic, taste, vibe, preference, etc. based on certain user information.

In the implementation illustrated in FIG. 3A, in addition to instructing the generative model that generated LLM output 302 to generate a user's aesthetic, taste, vibe, preference, etc. based on certain user information, the natural language prompts processed in generating LLM output 302 may have also instructed the generative model to generate targeted queries designed to retrieve visual content items 314 that represent, illustrate, or are otherwise expressive of aspects of the generated user's aesthetic, taste, vibe, preference, etc. According to certain aspects of the present disclosure, the natural language prompts may have instructed the generative model to generate the queries specifically in view of the layout and/or arrangement of the content presented in user interface 310. For example, the natural language prompts may specify that queries are to be generated to identify four content items that represent and/or illustrate particular aspects relating to the user's aesthetic, taste, vibe, preference, etc. In the illustrated implementation, the natural language prompt may further specify that the first content item to be included in the layout is to be directed to an environmental scene related to the user's aesthetic, taste, vibe, preference, etc., the second content item to be included in the layout is to be directed to house décor related to the user's aesthetic, taste, vibe, preference, etc., the third content item to be included in the layout is to be directed to an outfit related to the user's aesthetic, taste, vibe, preference, etc., and the fourth content item to be included in the layout is to be directed to an activity related to the user's aesthetic, taste, vibe, preference, etc. Further, the natural language prompt may specify that a certain number of queries (e.g., 1, 2, 3, 5, 10, 15, etc.) be generated for each of the content items to be included in user interface 310.

Alternatively and/or in addition, in exemplary implementations where the natural language prompt was configured to determine one or more features and/or objects (e.g., travel destinations, animals, horoscopes, colors, celebrities, etc.) linked to the aspects of the user, indication 312 may also include in addition to or in place of the summary or phrase associated with an aspect of the user and visual content items 314 may represent, illustrate, or otherwise be expressive of the linked features and/or objects.

Accordingly, the queries generated by the generative model and included in LLM output 302 may have been performed (e.g., by a search or recommendation service employing one or more trained models, etc.) in determining content items 314 from a corpus of content items. Optionally, the search or recommendation service may also consider user information associated with the user of client device 300 in determining content items 314, so that the determined content items are more relevant to the user. As illustrated in FIG. 3A, user interface 310 may display the content items determined in response to the queries and may include content item 314-1, which includes a representation of a mountain scene, content item 314-2, which includes a representation of an outfit, content item 314-3, which includes a representation of a living room, and content item 314-4, which includes a representation of a person fishing on a lake.

As shown in FIG. 3B, LLM output 302 may be processed to serve content on a client device via a user interface in accordance with a predetermined layout 320. As illustrated, layout 320 may include an indication 322 of a summary or phrase associated with an aspect of the user, such as the user's aesthetic, taste, vibe, preference, etc., and/or features and/or objects linked to the user, which may have been determined by a generative model and specified in LLM output 302 and content item positions 324 at which visual content items may be presented.

According to aspects of the present disclosure, each content item position 324 may relate to particular aspects of the user's aesthetic, taste, vibe, preference, etc., and LLM output 302 may include queries that specifically correspond to a respective content item position 324. For example, queries A 306-1 may correspond to first content item position 324-1, which may be associated with content items directed to an environmental scene related to the user's aesthetic, taste, vibe, preference, etc. Accordingly, queries A 306-1 may include queries configured to retrieve visual content items that are directed to an environmental scene related to the user's aesthetic, taste, vibe, preference, etc. Similarly, queries B 306-2 may correspond to second content item position 324-2, which may be associated with content items directed to house décor related to the user's aesthetic, taste, vibe, preference, etc., and may include queries configured to retrieve visual content items that are directed to house décor related to the user's aesthetic, taste, vibe, preference, etc.; queries C 306-3 may correspond to third content item position 324-3, which may be associated with content items directed to an outfit related to the user's aesthetic, taste, vibe, preference, etc., and may include queries configured to retrieve visual content items that are directed to an outfit related to the user's aesthetic, taste, vibe, preference, etc.; and queries D 306-4 may correspond to first content item position 324-4, which may be associated with content items directed to an activity related to the user's aesthetic, taste, vibe, preference, etc., and may include queries configured to retrieve visual content items that are directed to an activity related to the user's aesthetic, taste, vibe, preference, etc.

Accordingly, the queries generated by the generative model and included in LLM output 302 may be performed (e.g., by a search or recommendation service employing one or more trained models, etc.) to determine content items from a corpus of content items to be presented at content item positions 324.

As shown in FIGS. 3C and 3D, LLM output 322 may be processed to serve content (e.g., interactive personalized questionnaire, quiz, survey, poll, etc.) via user interfaces 332 (e.g., user interfaces 332-1, 332-2, 332-3, 332-4, and 332-5) on client device 330. As illustrated, LLM output 322 may include questionnaire 324 and questionnaire response 326 which can be processed to present an interactive personalized questionnaire, quiz, survey, poll, etc., on client device 330. Accordingly, LLM output 322 may have been generated by a generative model in response to processing one or more natural language prompts configured to instruct the generative model to generate a questionnaire, quiz, survey, poll, etc. Additionally, the generative model may also have been instructed to generate a conclusion, summary, inference, etc. regarding the user based on the user's responses and one or more targeted queries corresponding to the conclusions, summaries, inferences, etc. and/or responses to the questions of the questionnaire, quiz, survey, poll, etc. that are designed to retrieve visual content items that represent, illustrate, or otherwise relate to the questionnaire, quiz, survey, poll, etc., the user's response to the questionnaire, quiz, survey, poll, etc., and/or the conclusion, summary, inference, etc. generated based on the user's responses. Accordingly, LLM output 322 may include a questionnaire, quiz, survey, poll, etc. that includes one or more questions, along with one more possible responses to each question, one or more conclusions, summaries, inferences, etc. for each possible combination of user responses, and one or more queries corresponding to the conclusions, summaries, inferences, etc. and/or responses to the questions of the questionnaire, quiz, survey, poll, etc.

As illustrated in FIG. 3C, the interactive personalized questionnaire, quiz, survey, poll, etc. may include a series of questions and multiple choice responses, which may be presented via user interfaces 332-1 through 332-4. The generative model may generate the personalized questionnaire, quiz, survey, poll, etc. based on user information provided to the generative model via one or more natural language prompts. For example, the personalized questionnaire, quiz, survey, poll, etc. included in LLM output 322 may relate to an interest, a topic, a category, etc. of the user that is determined based on the user information included in the natural language prompt. Additionally, the generative model may also generate one or more conclusions, summaries, inferences, etc. relating to the questionnaire, quiz, survey, poll, etc. based on the user's responses to the questions included in the questionnaire, quiz, survey, poll, etc. and may be included in LLM output 322 and presented via user interface 332-5. For example, a conclusion, summary, and/or inference may be generated for each combination of responses to the questions included in the questionnaire, quiz, survey, poll, etc.

Further, as shown in FIG. 3D, one or more queries 328 that correspond to questionnaire responses 326 may be generated by the generative model and included in LLM output 322. For example, for each response to the questions of the questionnaire, quiz, survey, poll, etc., the generative model may generate one or more queries configured to retrieve content items related to the corresponding response. Alternatively and/or in addition, one or more queries may be generated for each generated conclusion, summary, and/or inference, where the queries relate to the corresponding conclusion, summary, and/or inference.

Accordingly, as the user responds to each of the questions presented in the personalized questionnaire, quiz, survey, poll, etc., the user's responses may be logged. According to certain aspects of the present disclosure, each subsequent question of the questionnaire, quiz, survey, poll, etc. may be determined based on the user's previously submitted responses. In addition to logging the user's responses to the questions, the generated queries associated with the user's responses may also be logged and/or aggregated. Based on the user's responses to the questions of the questionnaire, quiz, survey, poll, etc., the conclusion, summary, and/or inference relating to the user's response may be determined and presented to the user on client device 330, via user interface 332-5. For example, the conclusion, summary, and/or inference corresponding to the user's combination of responses may be determined from the conclusions, summaries, and/or inferences determined by the generative model.

Additionally, the queries associated with the user's responses and/or the queries associated with the conclusion, summary, and/or inference may be performed (e.g., by a search or recommendation service employing one or more trained models, etc.) in determining one or more content items from a corpus of content items for presentation on client device 330 via user interface 332-5. Optionally, the search or recommendation service may also consider user information associated with the user of client device 300 in determining the content items, so that the determined content items are more relevant to the user. Accordingly, as shown in FIG. 3C, the conclusion, summary, and/or inference (e.g., “Your fashion personality is: Eclectic fashionista”) may be presented along with the determined content items on client device 330 via user interface 332-5.

As shown in FIGS. 3E and 3F, model output 342 may be processed to serve content associated with a decision tree via user interfaces 352 (e.g., user interfaces 352-1 and 352-2) on client device 330. As illustrated, model output 342 may include decision tree 344 and queries 346. For example, decision tree 344 may include a root node corresponding to a content item that was included in a prompt processed by a generative model and child nodes connected to the root node that are associated with particular features, aspects, characteristics, etc. of the root node to which it is directly connected, and subsequent child nodes may be associated with more specific features pertaining to the respective parent node to which each child node is directly connected. Further, each node of decision tree 344 may also include phrases, captions, questions, etc. relating to each respective node of decision tree 344. Accordingly, decision tree 344 may facilitate exploration of different features and/or aspects stemming from the content item.

In the exemplary implementation illustrated in FIGS. 3E and 3F, the content item included in a prompt that was processed by a generative model to generate model output 342 may have included a representation of an outdoor wear outfit that included a Top Brand shirt and may present a look that may be categorized as an eclectic fashionista look. Accordingly, decision tree 344 may include a root node associated with the content item. Further, child nodes directly connected to the root node may be associated with different features and/or aspects of the content item. In the implementation illustrated in FIG. 3E, as described above, the root node of decision tree 344 may be associated with an image that included a representation of an outdoor wear outfit that included a Top Brand shirt and may present a look that may be categorized as an eclectic fashionista look. Accordingly, “eclectic fashionista looks?”, “outdoor wear?”, and “Top Brands shirts?” may correspond to three child nodes that are directly connected to the root node. Further child nodes that are directly connected to the child nodes may be associated with further features and/or aspects of each respective parent node to which they are directly connected.

In the implementation illustrated in FIG. 3E, in presenting content based on decision tree 344, the user may first be presented with user interface 352-1, which includes a question asking which feature of the content item the user desires to explore. Alternatively and/or in addition, user interface 352-1 may include a summary, phrase, caption, etc. regarding the content item associated with the root node of decision tree 344. Additionally, user interface 352-1 may include multiple questions (e.g., “eclectic fashionista looks?”, “outdoor wear?”, and “Top Brands shirts?”) that correspond to child nodes connected to the root node of decision tree 344. As illustrated in FIG. 3E, the user may have selected to further explore “eclectic fashionista looks?” which may correspond to one child node of decision tree 344 that is directly connected to the root node. Accordingly, user interface 352-2 may present a further question corresponding to the first selected child node asking which feature of the first selected child node the user desires to further explore. Alternatively and/or in addition, user interface 352-2 may include a summary, phrase, caption, etc. regarding the content item associated with the first selected child node of decision tree 344. Additionally, user interface 352-2 may include multiple questions (e.g., “bright colors?”, “modern cut?”, and “fitted looks?”) that correspond to child nodes connected to the first selected child node of decision tree 344. Further, user interface 352-2 may also include content items 355-1, which may have been determined and retrieved in response to queries 346 that are associated with the first selected child node of decision tree 344.

In response to user interface 352-2, the user may select any of the presented questions. In an exemplary implementation where the user selects “bright colors?”, which may correspond to a second selected child node, and the user may be presented with user interface 352-3. As shown in FIG. 3E, user interface 352-3 may present a further question corresponding to the second selected child node asking which feature of the second selected child node the user desires to further explore. Alternatively and/or in addition, user interface 352-3 may include a summary, phrase, caption, etc. regarding the content item associated with the root node of decision tree 344. Additionally, user interface 352-3 may include multiple questions (e.g., “resort wear?”, “sportswear?”, and “formal wear?”) that correspond to child nodes connected to the second selected child node of decision tree 344. Further, user interface 352-3 may also include content items 355-2, which may have been determined and retrieved in response to queries 346 that are associated with the second selected child node of decision tree 344. Accordingly, in response to a selection of one of the questions that corresponds to child nodes connected to the second selected child node of decision tree 344, the user may be presented with a further user interface presenting questions and content associated with further child nodes, and so on.

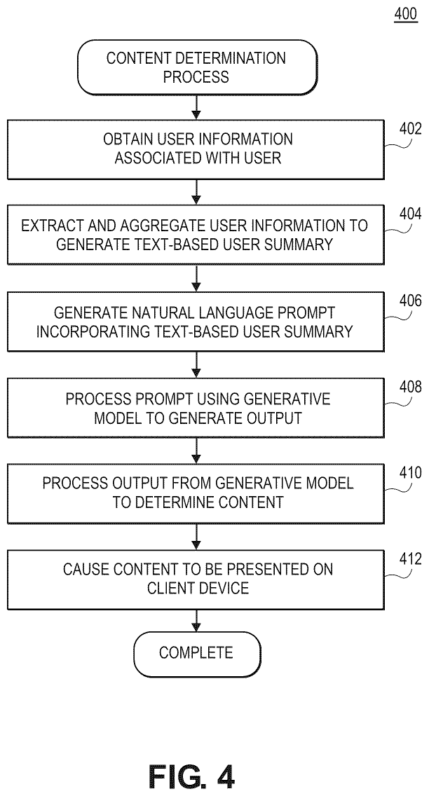

FIG. 4 is a flow diagram illustrating an exemplary content determination process, according to exemplary embodiments of the present disclosure.

As shown in FIG. 4, process 400 may begin with obtaining user information, as in step 402. User information may be stored and maintained by an online platform (e.g., a social networking service, social media platform, e-commerce platform, content recommendation services, search services, etc.) and may include information relating to the user, such as demographic information, user history information (e.g., content items with which the user interacted, types of interactions with content items, a frequency of interaction with content items, a recency of interaction with content items, etc.), items purchased by the user, user interests, user likes, user dislikes, user actions, and the like.

In step 404, textual information may be extracted and aggregated from the user information to generate a text-based user summary for the user. In exemplary implementations, the textual information may include textual information associated with the user information, such as annotations, title information, category information, object information, descriptive information, file information, generated captions, etc. associated with user actions the user may have taken and/or content items with which the user interacted, user demographic information, and the like. Accordingly, the text-based user summary may include an aggregation of textual information extracted from the user information and formed into a sequence of tokens, n-grams, and the like.

According to certain aspects of the present disclosure, in exemplary implementations where the user information may include visual content items that do not include textual information, a caption may be generated for any such visual content items. For example, visual content items not including textual information may be processed by a caption service to generate a caption for any such visual content items. According to exemplary implementations, the caption service may employ an image encoder and a language model, such as BLIP-2, FLAMINGO80B, VQAv2, GPT, etc. to process the content items and generate a caption for each content item. For example, a caption, as used herein, may include a short descriptive or explanatory text, that describes or explains the visual content item and/or the representations/illustrations included in the visual content item. Accordingly, any captions generated by a caption service may be included in the text-based user summary as textual information for any content items that do not include any associated textual information.

Additionally, in extracting and aggregating textual information from the user information to a generate text-based user summary, the user information may be weighted based on the parameters associated with features and/or parameters associated with the user information. For example, the items (e.g., user actions, content items, etc.) included in the user information may be weighted based on certain parameters, such as a recency of the action (e.g., more recent actions are provided a higher weight), a frequency of the action (e.g., more frequent actions a provided a higher weight), a type of the action (e.g., certain actions such as sharing a content item may be provided a higher weight than other actions, such as liking a content item, etc.), and the like. Accordingly, in extracting and aggregating the textual information associated with the user information to generate the text-based user summary, the textual information associated with user actions having higher weights may be prescribed greater importance relative to textual information associated with user actions that are associated with a lower weight. Accordingly, the text-based user summary may include a concatenation of the textual information extracted from the user information that is arranged in an order that corresponds to the weightings associated with the items included in the user information (e.g., the textual information may be arranged in an order of decreasing weights, increasing weights, and the like).

The text-based user summary may then be incorporated into a natural language prompt, as in step 406. The natural language prompt may be configured to be processed by a generative model, such as an LLM, to generate a particular output for the determination and/or generation of customized content to be served to a user, and, in step 408, the natural language prompt may be processed by a generative model to generate an output. Accordingly, the natural language prompt may specify the type of output to be generated, how the text-based user summary is to be processed (e.g., weightings, an order of importance, etc.), and the like. In an exemplary implementation, the natural language prompt may instruct the generative model to generate an output that includes a summary or phrase relating to an aspect of the user (e.g., a user's aesthetic, taste, vibe, preference, etc.), along with one or more queries configured to retrieve visual content items that may be illustrative of the aspect of the user (e.g., the user's aesthetic, taste, vibe, preference, etc.), based on the text-based user summary. Further, the natural language prompt may specify that the text terms included in the text-based user summary are arranged in a certain order of importance (e.g., decreasing, increasing, etc.) based on weightings associated with corresponding features within the user information.

Alternatively and/or in addition, the natural language prompt may instruct the generative model to generate a questionnaire, quiz, survey, poll, etc. based on the text-based user summary extracted from the user information. The generated questionnaire, quiz, survey, poll, etc. may relate to a topic, interest, subject, etc. of the user that may be determined from the text-based user summary and may include one or more questions, and each question may include two or more selectable responses. Further, the natural language prompt may further instruct the generative model to generate one or more conclusions, summaries, inferences, etc. (e.g., for each combination of user responses) relating to the questionnaire, quiz, survey, poll, etc. based on the user's responses to the questions included in the questionnaire, quiz, survey, poll, etc. According to certain aspects of the present disclosure, the natural language prompt may also specify that the generative model generate one or more targeted queries for each conclusion, summary, inference, etc. and/or response associated with the questions of the questionnaire, quiz, survey, poll, etc. that are configured to request visual content items that may relate to the corresponding response in the questionnaire, quiz, survey, poll, etc. Generation of a natural language prompt that instructs a generative model to generate a summary or phrase that describes an aspect of the user, such as a user's aesthetic, taste, vibe, preference, etc., and/or a questionnaire, quiz, survey, poll, etc. are illustrative and are not intended to be limiting. Accordingly, the natural language prompt may be configured to generate other customized content for a user based on a text-based user summary generated from user information.

In step 410, the output from the generative model may be processed to determine the content to be presented to the user (e.g., a user's aesthetic, taste, vibe, preference, etc., features and/or object linked to the user, a questionnaire, quiz, survey, poll, etc.), and in step 412, the content may be presented on a client device.

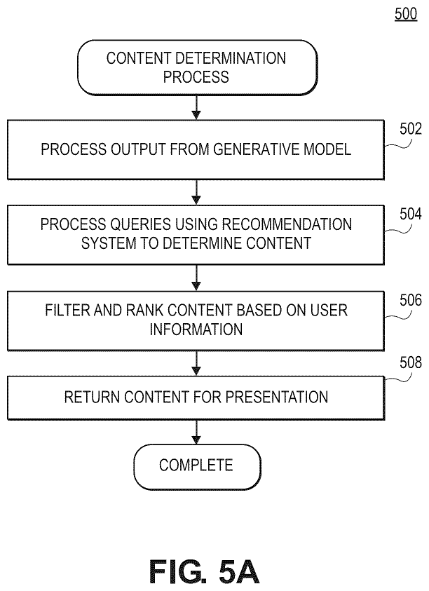

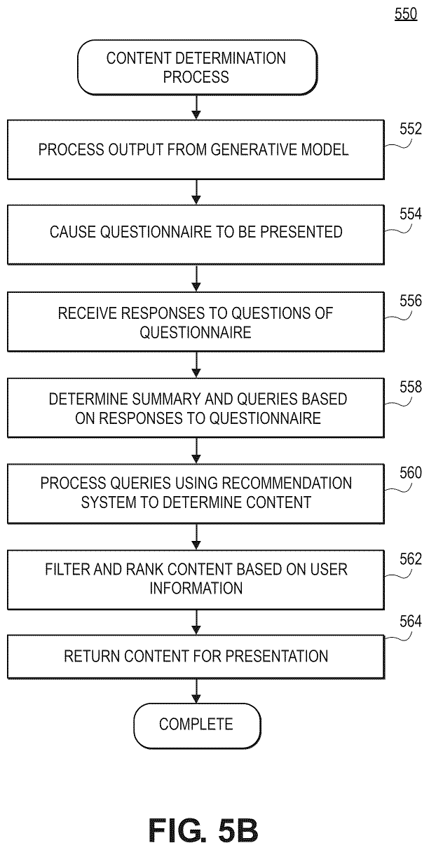

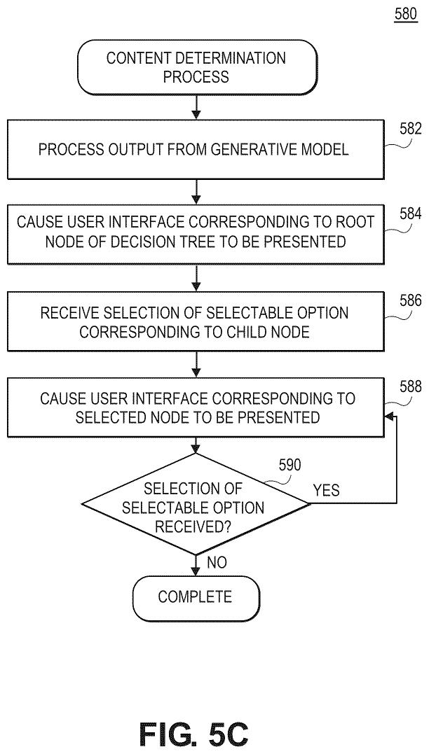

FIGS. 5A-5C are flow diagrams illustrating exemplary content determination and presentation processes, according to exemplary embodiments of the present disclosure. FIG. 5A illustrates an exemplary process for determination of a user's aesthetics, tastes, preferences, and/or vibes and also identify relevant content items that are representative of the determined aesthetics, tastes, preferences, and/or vibes, FIG. 5B illustrates an exemplary process for determination of a personalized questionnaire, quiz, survey, poll, etc., and FIG. 5C illustrates an exemplary process for determination of a personalized content using a decision tree.

As shown in FIG. 5A, process 500 may begin with processing an output from a generative model, as in step 502. In an exemplary implementation the output may have been generated by generative model in response to processing of a natural language prompt instructing the generative model to generate an output that includes a summary or phrase that describes an aspect of the user, such as a user's aesthetic, taste, vibe, preference, etc., one or more features or objects (e.g., travel destinations, animals, horoscopes, colors, celebrities, etc.) linked to the aspects of the user, as well as one or more queries configured to retrieve visual content items that may be representative of and/or embody the aspect of the user, such as user's aesthetic, taste, vibe, preference, etc., based on textual information extracted from certain user information. Accordingly, in one exemplary implementation, the output may specify a user's aesthetic, taste, vibe, preference, etc., as well as one or more queries configured to retrieve visual content items that may be representative of and/or embody the user's aesthetic, taste, vibe, preference, etc. In other implementations, the output from the generative model may specify other aspects of the user and/or other types of content that may be presented to the user.

In step 504, queries included in the output from the generative model may be performed by a recommendation system to determine content that is responsive to the queries. According to aspects of the present disclosure, the queries may correspond to the aspect of the user, such as particular aspects of the user's aesthetic, taste, vibe, preference, one or more features or objects (e.g., travel destinations, animals, horoscopes, colors, celebrities, etc.) linked to the aspects of the user, and the like that may be presented in a particular arrangement, configuration, and/or layout. Optionally, the content may be determined using user information, so as to make the content more relevant to the user.

After determination of the content, the content may be filtered and ranked (e.g., based on user information), as in step 506, and the content may be returned to be presented on a client device, as in step 508. For example, the user's aesthetic, taste, vibe, preference, etc., as well as the content items determined in step 506 may be presented to the user on a client device. In certain implementations, the content may be presented in accordance with a predetermined arrangement, configuration, and/or layout.

As shown in FIG. 5B, process 550 may begin with processing an output from a generative model, as in step 552. In an exemplary implementation the output may have been generated by generative model in response to processing of a natural language prompt instructing the generative model to generate an output that includes a questionnaire, quiz, survey, poll, etc., conclusions, summaries, inferences, etc. relating to the user based on the user's responses to questions included in the questionnaire, quiz, survey, poll, etc., and queries for each conclusion and/or response to the questions included in the questionnaire, quiz, survey, poll, etc. based on textual information extracted from certain user information. Accordingly, the output may specify a questionnaire, quiz, survey, poll, etc., conclusions, summaries, inferences, etc. relating to the user based on the user's responses to questions included in the questionnaire, quiz, survey, poll, etc., and queries for each conclusion and/or response to the questions included in the questionnaire, quiz, survey, poll, etc. In other implementations, the output from the generative model may specify other types of content that may be presented to the user.

In step 554, the questionnaire, quiz, survey, poll, etc. may be presented, via a user interface, to a user on a client device. For example, the questionnaire, quiz, survey, poll, etc. may be presented as a series of questions and corresponding responses to each question. According to certain aspects of the present disclosure, the generated questions, along with questions of the questionnaire may be presented to a user on a client device, and in step 556, responses to the questions of the questionnaire, quiz, survey, poll, etc. For example, the responses may be received via interactions with the user interface via which the questions are presented on the client device.

In step 558, a conclusion, summary, inference, etc. relating to the user and one or more queries may be determined based on the user's responses to the questions included in the questionnaire, quiz, survey, poll, etc. For example, the generative model may have generated one or more conclusions, summaries, inferences, etc. in connection with the responses to the questions of the questionnaire, quiz, survey, poll, etc. (e.g., a conclusion, summary, inference, etc. or each possible combination of responses) and one or more queries for each conclusion and/or each response to the questions included in the questionnaire, quiz, survey, poll, etc. Accordingly, based on the user's responses to the questions of the questionnaire, quiz, survey, poll, etc. a conclusion, summary, and/or inference (e.g., corresponding to the combination of user's responses) may be determined and one or more queries corresponding to the conclusion, summary, inference, and/or the responses indicated by the user may also be determined. The conclusion, summary, and/or inference may relate to the user in connection with the topic of the questionnaire, quiz, survey, poll, etc. based on the user's responses to the questions of the questionnaire, quiz, survey, poll, etc.

In step 560, queries determined in step 558 may be performed by a recommendation system to determine content that is responsive to the queries. According to aspects of the present disclosure, the queries may correspond to conclusion, summary, and/or inference that may have been determined based on the user's responses to the questions of the questionnaire, quiz, survey, poll, etc. Optionally, the content may be determined using user information, so as to make the content more relevant to the user.

After determination of the content, the content may be filtered and ranked (e.g., based on user information), as in step 562, and the content may be returned to be presented on a client device, as in step 564. For example, the conclusion, summary, and/or inference, as well as the content items determined in step 562 may be presented to the user on a client device.

As shown in FIG. 5C, process 580 may begin with processing an output from a generative model, as in step 582. In an exemplary implementation the output may have been generated by generative model in response to processing of a prompt including a non-textual content item that instructs the generative model to generate an output that includes a decision tree relating to the user based on the content item and queries for each node of the decision tree. Accordingly, the output may specify a decision tree with a root node that is associated with the content item that was included in the prompt, child nodes that re associated with a particular feature, aspect, characteristic, etc. of the parent node to which it is directly connected. Additionally, the output may further include a phrase, question, or caption describing or representing each node of the decision tree, as well as one or more queries configured to retrieve content items that are relevant to each node of the decision tree.

In step 584, a user interface corresponding to the root node of the decision tree may be presented, along with multiple selectable options. For example, the user interface corresponding to the root node of the decision tree may include the content item associated with the root node, a phrase, caption, summary, question, etc. of the root node, and multiple selectable options that correspond to child nodes directly connected to the root node. The selectable options may be represented as phrase, caption, summary, question, etc. generated for each child node. Optionally, one or more queries included in the output associated with the root node may be performed to retrieve content items relevant to the root node of the decision tree, and the retrieved content items may be presented via the user interface. A user may, via an interaction with the user interface, select one of the selectable options to select the corresponding child node of selected selectable option, as in step 586.

In step 588, a user interface corresponding to the selected child node of the decision tree may be presented, along with multiple selectable options. For example, the user interface corresponding to the selected child node of the decision tree may a phrase, caption, summary, question, etc. of the selected child node, and multiple selectable options that correspond to child nodes directly connected to the selected child node. The selectable options may be represented as phrase, caption, summary, question, etc. generated for each child node. Optionally, one or more queries included in the output associated with the root node may be performed to retrieve content items relevant to the root node of the decision tree.

In step 590, it may be determined if a further selection of one of the selectable option is received. If a further selection is received, process 580 returns to step 588. If no such further selection is received, process 580 completes.

FIG. 6 is a block diagram illustrating an exemplary computing resource, according to exemplary embodiments of the present disclosure.

In exemplary implementations, multiple such computing resources 600 may be included in the system. Further, it is noted that computing resource 600 is a logical configuration and is not necessarily an actual configuration. Indeed, there may be numerous ways in which computing resource 600 may be implemented, and FIG. 6 should be viewed as illustrative and not limiting. In operation, each of these devices (or groups of devices) may include computer-readable and computer-executable instructions that reside on computing resource 600, as will be discussed further below.

Computing resource 600 may include one or more controllers/processors 604, that may each include a CPU for processing data and computer-readable instructions, and memory 605 for storing data and instructions. Memory 605 may individually include volatile RAM, non-volatile ROM, non-volatile MRAM, and/or other types of memory. Computing resource 600 may also include a data storage component 608 for storing data, user actions, content items, user information, content information, other supplemental information, etc. Each data storage component may individually include one or more non-volatile storage types such as magnetic storage, optical storage, solid-state storage, etc. Computing resource 600 may also be connected to removable or external non-volatile memory and/or storage (such as a removable memory card, memory key drive, networked storage, etc.) through input/output device interfaces 632.

Computer instructions for operating computing resource 600 and its various components may be executed by the controller(s)/processor(s) 604, using memory 605 as temporary “working” storage at runtime. The computer instructions may be stored in a non-transitory manner in non-volatile memory 605, storage 608, or an external device(s). Alternatively, some or all of the executable instructions may be embedded in hardware or firmware on computing resource 600 in addition to or instead of software.

For example, memory 605 may store program instructions that when executed by the controller(s)/processor(s) 604 cause the controller(s)/processors 604 to process shared natural language prompts, etc. using generative model 606 to determine and/or serve content, as discussed herein.

Computing resource 600 also includes input/output device interface 632. A variety of components may be connected through input/output device interface 632. Additionally, computing resource 600 may include address/data bus 624 for conveying data among components of computing resource 600. Each component within computing resource 600 may also be directly connected to other components in addition to (or instead of) being connected to other components across bus 624.

The disclosed implementations discussed herein may be performed on one or more computing resources, such as computing resource 600 discussed with respect to FIG. 6 or performed on a combination of one or more computing resources. Further, the components of the computing resource 600, as illustrated in FIG. 6, are exemplary, and may be located as a stand-alone device or may be included, in whole or in part, as a component of a larger device or system.

The above aspects of the present disclosure are meant to be illustrative. They were chosen to explain the principles and application of the disclosure and are not intended to be exhaustive or to limit the disclosure. Many modifications and variations of the disclosed aspects may be apparent to those of skill in the art. It should be understood that, unless otherwise explicitly or implicitly indicated herein, any of the features, characteristics, alternatives or modifications described regarding a particular embodiment herein may also be applied, used, or incorporated with any other embodiment described herein, and that the drawings and detailed description of the present disclosure are intended to cover all modifications, equivalents and alternatives to the various embodiments as defined by the appended claims. Persons having ordinary skill in the field of computers, communications, media files, and machine learning should recognize that components and process steps described herein may be interchangeable with other components or steps, or combinations of components or steps, and still achieve the benefits and advantages of the present disclosure. Moreover, it should be apparent to one skilled in the art that the disclosure may be practiced without some, or all of the specific details and steps disclosed herein.

Aspects of the disclosed system may be implemented as a computer method or as an article of manufacture such as a memory device or non-transitory computer-readable storage medium. The computer-readable storage medium may be readable by a computer and may comprise instructions for causing a computer or other device to perform processes described in the present disclosure. The computer-readable storage media may be implemented by a volatile computer memory, non-volatile computer memory, hard drive, solid-state memory, flash drive, removable disk and/or other media. In addition, components of one or more of the modules and engines may be implemented in firmware or hardware.

The data and/or computer-executable instructions, programs, firmware, software and the like (also referred to herein as “computer-executable” components) described herein may be stored on a computer-readable medium that is within or accessible by computers or computer components such as computing resource 600, client device 110, or to any other computers or control systems, and having sequences of instructions which, when executed by a processor (e.g., a central processing unit, or “CPU”), cause the processor to perform all or a portion of the functions, services and/or methods described herein. Such computer-executable instructions, programs, software and the like may be loaded into the memory of one or more computers using a drive mechanism associated with the computer readable medium, such as a floppy drive, CD-ROM drive, DVD-ROM drive, network interface, or the like, or via external connections.

Some implementations of the systems and methods of the present disclosure may also be provided as a computer-executable program product including a non-transitory machine-readable storage medium having stored thereon instructions (in compressed or uncompressed form) that may be used to program a computer (or other electronic device) to perform processes or methods described herein. The machine-readable storage media of the present disclosure may include, but is not limited to, hard drives, floppy diskettes, optical disks, CD-ROMs, DVDs, ROMs, RAMs, erasable programmable ROMs (“EPROM”), electrically erasable programmable ROMs (“EEPROM”), flash memory, magnetic or optical cards, solid-state memory devices, or other types of media/machine-readable medium that may be suitable for storing electronic instructions. Further, implementations may also be provided as a computer-executable program product that includes a transitory machine-readable signal (in compressed or uncompressed form).

As used herein, the terms “product” or “item,” or like terms, may be used to refer to any good or service associated with a brand, and which may be depicted or referenced in one or more visual assets or audio content, or may be the subject of one or more advertisement creatives or other creative works. For example, products may include commercial goods, e.g., tangible objects that may be bought or sold, such as automobiles, books, clothing, computers, furniture, luggage, or others, as well as services, e.g., business services, social services, or personal services, such as travel, cruises, hair salons, personal training, legal or accounting services, or others.

It should be understood that, unless otherwise explicitly or implicitly indicated herein, any of the features, characteristics, alternatives or modifications described regarding a particular implementation herein may also be applied, used, or incorporated with any other implementation described herein, and that the drawings and detailed description of the present disclosure are intended to cover all modifications, equivalents and alternatives to the various implementations as defined by the appended claims. Moreover, with respect to the one or more methods or processes of the present disclosure described herein, including but not limited to the flow chart shown in FIGS. 4 and 5A-5C, orders in which such methods or processes are presented are not intended to be construed as any limitation on the claimed inventions, and any number of the method or process steps or boxes described herein can be combined in any order and/or in parallel to implement the methods or processes described herein. Additionally, it should be appreciated that the detailed description is set forth with reference to the accompanying drawings, which are not drawn to scale.

Conditional language, such as, among others, “can,” “could,” “might,” or “may,” unless specifically stated otherwise, or otherwise understood within the context as used, is generally intended to convey in a permissive manner that certain implementations could include, or have the potential to include, but do not mandate or require, certain features, elements and/or steps. In a similar manner, terms such as “include,” “including” and “includes” are generally intended to mean “including, but not limited to.” Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation.

The elements of a method, process, or algorithm described in connection with the implementations disclosed herein can be embodied directly in hardware, in a software module stored in one or more memory devices and executed by one or more processors, or in a combination of the two. A software module can reside in RAM, flash memory, ROM, EPROM, EEPROM, registers, a hard disk, a removable disk, a CD ROM, a DVD-ROM or any other form of non-transitory computer-readable storage medium, media, or physical computer storage known in the art. An example storage medium can be coupled to the processor such that the processor can read information from, and write information to, the storage medium. In the alternative, the storage medium can be integral to the processor. The storage medium can be volatile or nonvolatile. The processor and the storage medium can reside in an ASIC. The ASIC can reside in a user terminal. In the alternative, the processor and the storage medium can reside as discrete components in a user terminal.

Disjunctive language such as the phrase “at least one of X, Y, or Z,” or “at least one of X, Y and Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain implementations require at least one of X, at least one of Y, or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

Language of degree used herein, such as the terms “about,” “approximately,” “generally,” “nearly” or “substantially” as used herein, represent a value, amount, or characteristic close to the stated value, amount, or characteristic that still performs a desired function or achieves a desired result. For example, the terms “about,” “approximately,” “generally,” “nearly” or “substantially” may refer to an amount that is within less than 10% of, within less than 5% of, within less than 1% of, within less than 0.1% of, and within less than 0.01% of the stated amount.

Although the invention has been described and illustrated with respect to illustrative implementations thereof, the foregoing and various other additions and omissions may be made therein and thereto without departing from the spirit and scope of the present disclosure.

While various novel aspects of the disclosed subject matter have been described, it should be appreciated that these aspects are exemplary and should not be construed as limiting. Variations and alterations to the various aspects may be made without departing from the scope of the disclosed subject matter.

1. A computing system, comprising:
one or more processors; and
a memory storing program instructions that, when executed by the one or more processors, cause the one or more processors to at least:
obtain a plurality of user information associated with a user that includes information associated with a first plurality of content items with which the user has interacted;
extract textual information associated with the plurality of content items;
aggregate the textual information to generate a text-based user summary associated with the user;
generate an input for a generative model, the input including the text-based user summary and instructions to the generative model to generate an output, based at least in part on the text-based user summary, wherein the generative model output includes a summary of an aspect of the user and a plurality of queries related to the aspect of the user;
process the input by the generative model to generate the output, the output including the summary of the aspect of the user and the plurality of queries;
determine a second plurality of content items that are responsive to the plurality of queries generated by the generative model; and
provide the summary and at least a portion of the second plurality of content items to a client device associated with the user for presentation.

2. The computing system of claim 1, wherein the summary relates to at least one of an aesthetic, a taste, a preference, a location, an animal, or a color associated with the user.

3. The computing system of claim 1, wherein:
the first plurality of content items include a plurality of associated weights; and
the textual information is aggregated in accordance with the plurality of associated weights in generating the text-based user summary.

4. The computing system of claim 3, wherein the plurality of weights are determined based at least in part on at least one of a recency of one or more of the first plurality of content items, a type of interaction with one or more of the first plurality of content items, or a frequency of interaction with one or more of the first plurality of content items.

5. The computing system of claim 1, wherein:
the summary and the at least the portion of the second plurality of content items are presented according to a predetermined layout;
the predetermined layout includes a plurality of content items layout locations for presenting a respective content item of the second plurality of content items;
the plurality of queries includes a plurality of subset of queries; and
one or more of the plurality of subset of queries corresponds to a respective content item layout location of the plurality of content items layout locations.

6. A computer-implemented method, comprising:
obtaining a first plurality of textual information associated with a first content item with which a user has interacted;
generating a prompt, the prompt including the first plurality of textual information and instructions to generate, based at least in part on the first plurality of textual information, a customized content and a first plurality of queries related to the customized content;
processing the prompt using a generative model, wherein the generative model is configured to generate an output that includes the customized content and the first plurality of queries;
processing at least some of the first plurality of queries to determine a second plurality of content items that are responsive to the plurality of queries; and
providing the customized content and at least a portion of the second plurality of content items to a user device for presentation.

7. The computer-implemented method of claim 6, further comprising:
aggregating a second plurality of textual information associated with a first plurality of content items to generate a text-based user summary,
wherein:
the first plurality of content items is determined, based on content items with which a user has interacted, from a user history associated with the user;
the first content item is one of the first plurality of content items; and
the prompt includes the text-based user summary.

8. The computer-implemented method of claim 7, wherein:
the first plurality of content items are assigned a plurality of weights; and
aggregating the second plurality of textual information associated with the first plurality of content items is performed in accordance with the plurality of weights.

9. The computer-implemented method of claim 7, wherein the customized content includes at least one of an aesthetic of the user, a taste or the user, or an object linked to the user.

10. The computer-implemented method of claim 8, wherein the plurality of weights are determined based at least in part on at least one of a recency of one or more of the first plurality of content items, a type of interaction with one or more of the first plurality of content items, or a frequency of interaction with one or more of the first plurality of content items.

11. The computer-implemented method of claim 10, wherein:
the at least the portion of the second plurality of content items are presented according to a predetermined layout;
the predetermined layout includes a plurality of content items layout locations for presenting a respective content item of the second plurality of content items;
each of the plurality of plurality of content items layout locations corresponds to a respective aspect of the taste of the user;
the plurality of queries includes a plurality of subset of queries; and
one or more of the plurality of subset of queries corresponds to a respective content item layout location of the plurality of content items layout locations.

12. The computer-implemented method of claim 11, wherein:
the customized content includes a questionnaire; and
one or more of the first plurality of queries corresponds to a possible response to a question of the questionnaire.

13. The computer-implemented method of claim 12, wherein the prompt further instructs the generative model to, based at least in part on the text-based user summary, generate a plurality of conclusions associated with the questionnaire.

14. The computer-implemented method of claim 13, further comprising:
in response to causing the customized content to be presented to the user:
receiving interactions specifying responses to questions of the questionnaire;
determining, based at least in part on the responses, a conclusion from the plurality of conclusions; and
selecting, based at least in part on the responses, one or more queries of the first plurality of queries that are associated with the conclusion.

15. The computer-implemented method of claim 13, wherein one or more of the plurality of conclusions corresponds to a respective combination of responses to questions included in the questionnaire.

16. The computer-implemented method of claim 6, wherein:
the prompt includes the first content item;
the generative model includes a multimodal generative model; and
the customized content includes a decision tree having a root node and a plurality of child nodes;
the root node is associated with the first content item; and
one or more child nodes of the plurality of child nodes is associated with a feature of a respective parent node to which it is directed connected.

17. A method, comprising:
obtaining a plurality of user information associated with a user that includes information associated with a first plurality of content items with which the user has interacted;
extracting textual information associated with the plurality of content items;
aggregating the textual information to generate a text-based user summary associated with the user;
generating an input for a generative model, the input including the text-based user summary and instructions to the generative model to generate an output, based at least in part on the text-based user summary, wherein the generative model output includes a questionnaire, a plurality of conclusions, and a plurality of queries;
processing the input by the generative model to generate the output that includes the questionnaire, the plurality of conclusions, and the first plurality of queries;
providing the questionnaire to a client device associated with the user for presentation;
receiving, from the client device and via interactions with the client device, responses to questions included in the questionnaire;
determining, based at least in part on the responses, a conclusion from the plurality of conclusions;
determining, based at least in part on the responses, a second plurality of queries from the first plurality of queries;
processing the second plurality of queries to determine a second plurality of content items that are responsive to the second plurality of queries; and
providing the conclusion and at least a portion of the second plurality of content items to the client device for presentation.

18. The method of claim 17, wherein:
the first plurality of content items are assigned a plurality of weights; and
aggregating the textual information to generate the text-based user summary is performed in accordance with the plurality of weights.

19. The method of claim 18, wherein the plurality of weights are determined based at least in part on at least one of a recency of one or more of the first plurality of content items, a type of interaction with one or more of the first plurality of content items, or a frequency of interaction with one or more of the first plurality of content items.

20. The method of claim 17, wherein one or more of the first plurality of queries is associated with at least one of:
a conclusion from the plurality of conclusions; or
a response to a question of the questionnaire.
